(19) United States
(12) Patent Application Publication
(10) Pub. No.: US 2024/0053737 A1
(43) Pub. Date: Feb. 15, 2024

(54) CENTRAL MANAGEMENT DEVICE, AND METHOD FOR CONTROLLING CENTRAL MANAGEMENT DEVICE

(71) Applicant: FANUC CORPORATION, Minamitsuru-gun, Yamanashi (JP)

(72) Inventors: Shingo KOMIYA, Minamitsuru-gun, Yamanashi-ken (JP); Tatsuhiro UCHIYAMA, Minamitsuru-gun, Yamanashi-ken (JP)

(21) Appl. No.: 18/267,641

(22) PCT Filed: Dec. 13, 2021
(86) PCT No.: PCT/JP2021/045732

§ 371 Date: Jun. 15, 2023

(30) Foreign Application Priority Data
Dec. 18, 2020 (JP) 2020-209956

(51) Int. Cl. G05B 23/02; G05B 19/418

(52) U.S. Cl. CPC G05B 23/0272; G05B 19/4185

(57) ABSTRACT

A central management device for managing operation states, including an abnormal state, of injection molding machines, includes a plurality of the injection molding machines respectively connected to shared appliances of the same kind, and includes: an operation state acquisition unit for acquiring data relating to the operation states of the respective injection molding machines; an individual information acquisition unit for acquiring data relating to connection states between the injection molding machines and the shared appliances; and a display control unit that controls a display unit so as to simultaneously display, on the display unit, the operation states between the respective injection molding machines and the shared appliances.

### TECHNICAL FIELD

The present invention relates to a centralized management apparatus (central management device) and a control method of the centralized management apparatus.

### BACKGROUND ART

Conventionally, there is a management device for displaying the operating states of a large number of injection molding machines (for example, JP 2004-164027 A).

### SUMMARY OF THE INVENTION

For example, in a case where an abnormality occurs in a shared device such as a power distribution panel which is connected to a plurality of injection molding machines and supplies electric power to the respective injection molding machines, even if the operating states of the injection molding machines are individually displayed, it is difficult for the user to find the abnormality occurring in the shared device, from the displayed information.

The present invention has the object of solving the aforementioned problem.

According to a first aspect of the present invention, there is provided a centralized management apparatus communicably connected to a plurality of production machines and configured to manage an operating state including an abnormal state of each of the production machines, wherein a plurality of the production machines are connected to each of shared devices of a same type, the centralized management apparatus including: an operating state acquisition unit configured to acquire data of the operating state of each of the production machines; a connection state acquisition unit configured to acquire data of a connection state between each of the shared devices and each of the production machines; and a display control unit configured to control a display unit to simultaneously display the operating state of each of the production machines and the connection state between each of the shared devices and each of the production machines, on the display unit.

According to a second aspect of the present invention, there is provided a control method of a centralized management apparatus that is communicably connected to a plurality of production machines and manages an operating state including an abnormal state of each of the production machines, wherein a plurality of the production machines are connected to each of shared devices of a same type, the control method including: an operating state acquisition step of acquiring data of the operating state of each of the production machines; a connection state acquisition step of acquiring data of a connection state between each of the shared devices and each of the production machines; and a display control step of causing a display unit to simultaneously display the operating state of each of the production machines and the connection state between each of the shared devices and each of the production machines.

According to the present invention, a user can easily find an abnormality occurring in a shared device connected to production machinery.

### BRIEF DESCRIPTION OF DRAWINGS

FIG. 1 is a block diagram illustrating a configuration of a centralized management apparatus and a touch panel display;

FIG. 2 is a diagram illustrating individual information of an injection molding machine stored in an individual information storage unit;

FIG. 3 is a diagram illustrating a display example of a display unit;

FIG. 4 is a diagram illustrating a display example of the display unit;

FIG. 5 is a diagram illustrating a display example of the display unit;

FIG. 6 is a diagram illustrating a display example of the display unit;

FIG. 7 is a diagram illustrating a display example of the display unit;

FIG. 8 is a diagram illustrating a display example of the display unit;

FIG. 9 is a diagram illustrating a display example of the display unit;

FIG. 10 is a diagram illustrating a display example of the display unit;

FIG. 11 is a diagram illustrating a display example of the display unit;

FIG. 12 is a diagram illustrating a display example of the display unit;

FIG. 13 is a diagram illustrating a display example of the display unit; and

FIG. 14 is a flowchart illustrating a flow of display control process performed in the centralized management apparatus.

### DETAILED DESCRIPTION OF THE INVENTION

### First Embodiment

### Overall Configuration

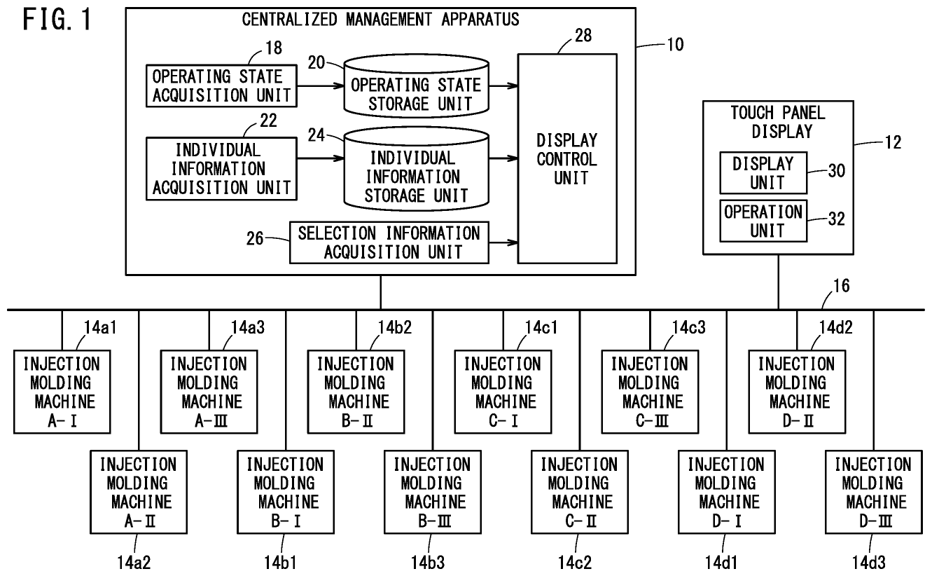

FIG. 1 is a block diagram showing a configuration of a centralized management apparatus 10 and a touch panel display 12. The centralized management apparatus 10 is connected to a large number of injection molding machines 14 installed in a factory via a communication line 16. The centralized management apparatus 10 is connected to the touch panel display 12 via the communication line 16. The communication line 16 may be a line having a closed communication network in the factory. The communication line 16 may be a line connected to a communication network outside the factory. Further, the communication line 16 may be a wired communication line. The communication line 16 may be a wireless communication line. The communication line 16 may be a line in which a wired communication line and a wireless communication line are mixed.

The following description will be given using an example in which twelve injection molding machines 14, i.e., an injection molding machine 14a1, an injection molding machine 14a2, an injection molding machine 14a3, an injection molding machine 14b1, an injection molding machine 14b2, an injection molding machine 14b3, an injection molding machine 14c1, an injection molding machine 14c2, an injection molding machine 14c3, an injection molding machine 14d1, an injection molding machine 14d2, and an injection molding machine 14d3 are installed in the factory. In the present embodiment, the injection molding machines 14 or the injection molding machine 14 will be written unless referring to a specific injection molding machine 14. The injection molding machines 14 each correspond to a production machine of the present invention.

Four types of shared devices are connected to the injection molding machines 14 of the present embodiment. The types of shared devices are a power distribution panel (power distribution board) that distributes electric power to the injection molding machines 14, a network hub that connects the injection molding machines 14 to a communication network, a water distributor that distributes cooling water to the injection molding machines 14, and a material distributor that distributes material to the injection molding machines 14. The type of the shared device may include a water discharger that discharges the cooling water used in the injection molding machines 14. In this case, the five types of shared devices are connected to the injection molding machines 14. A plurality of shared devices of each type are arranged in a factory. One shared device is connected to one or more of the injection molding machines 14.

The centralized management apparatus 10 includes an operating state acquisition unit 18, an operating state storage unit 20, an individual information acquisition unit 22, an individual information storage unit 24, a selection information acquisition unit 26, and a display control unit 28.

The operating state acquisition unit 18 periodically acquires the operating state of each injection molding machine 14. The operating state storage unit 20 stores the operating state of each injection molding machine 14 acquired by the operating state acquisition unit 18 in chronological order.

The operating state of the injection molding machine 14 includes at least the following four states. The four states include a state in which the injection molding machine 14 is in production, a state in which the injection molding machine 14 has completed production and is stopped, a state in which communication between the centralized management apparatus 10 and the injection molding machine 14 is interrupted, and a state in which an alarm is generated in the injection molding machine 14 and the injection molding machine 14 is stopped. The state in which the injection molding machine 14 is in production and the state in which the injection molding machine 14 has completed production and is stopped indicate that the injection molding machine 14 is in a normal state. The state in which communication between the centralized management apparatus 10 and the injection molding machine 14 is interrupted and a state in which an alarm is generated in the injection molding machine 14 and the injection molding machine 14 is stopped indicate that the injection molding machine 14 is in an abnormal state.

The individual information acquisition unit 22 acquires individual information of each injection molding machine 14. The individual information storage unit 24 stores the individual information of each injection molding machine 14 acquired by the individual information acquisition unit 22.

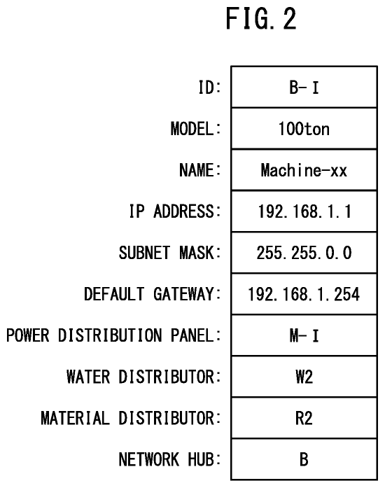

FIG. 2 is a diagram showing the individual information of the injection molding machine 14 stored in the individual information storage unit 24. The individual information of the injection molding machine 14 includes an ID unique to the injection molding machine 14, a model of the injection molding machine 14, a name of the injection molding machine 14, an IP address given to the injection molding machine 14, an address of a subnet of a network to which the injection molding machine 14 is connected, and an address of a default gateway of the network to which the injection molding machine 14 is connected.

Further, the individual information of the injection molding machine 14 includes the ID of each of the shared devices connected to the injection molding machine 14. The individual information illustrated in FIG. 2 is the individual information of the injection molding machine 14b1 whose ID is “B-I”. The individual information shown in FIG. 2 indicates that the injection molding machine 14b1 is connected to the following four shared devices. The four shared devices are a power distribution panel with an ID of “M-I”, a water distributor with an ID of “W2”, a material distributor with an ID of “R2”, and a network hub with an ID of “B”.

The selection information acquisition unit 26 acquires display format selection information and shared device selection information. The display format selection information is information indicating a display format selected by a user. The shared device selection information is information indicating a shared device selected by the user. The user operates an operation unit 32 to select a display format of a display unit 30 of the touch panel display 12 and a shared device to be displayed on the display unit 30. The touch panel display 12 will be described later.

The centralized management apparatus 10 includes a computer (not illustrated). The computer includes one or more arithmetic processing units (not illustrated) and one or more storages (not illustrated). The arithmetic processing unit includes, for example, a processor such as a central processing unit (CPU), a microprocessing unit (MPU) or the like, and a memory such as a ROM, a RAM or the like. The storage, for example, is a hard disk, a solid state drive (SSD), or the like. The operating state acquisition unit 18, the individual information acquisition unit 22, the selection information acquisition unit 26, and the display control unit 28 are realized by the arithmetic processing unit executing a program stored in the storage. The operating state storage unit 20 and the individual information storage unit 24 are storage areas provided in the storage.

The display control unit 28 controls the display unit 30 of the touch panel display 12, which will be described later, to simultaneously display the operating state of each injection molding machine 14 and the connection state between each shared device and each injection molding machine 14, on the display unit 30.

The touch panel display 12 includes the display unit 30 and the operation unit 32. The display unit 30 displays images, characters, symbols, and the like in accordance with a control signal from the display control unit 28. The operation unit 32 is a touch panel attached to the screen of the display unit 30 and is operated by the user. Various kinds of information are input from the user by a combination of the display displayed on the display unit 30 and the operation performed by the user through the operation unit 32.

### Display Format 1

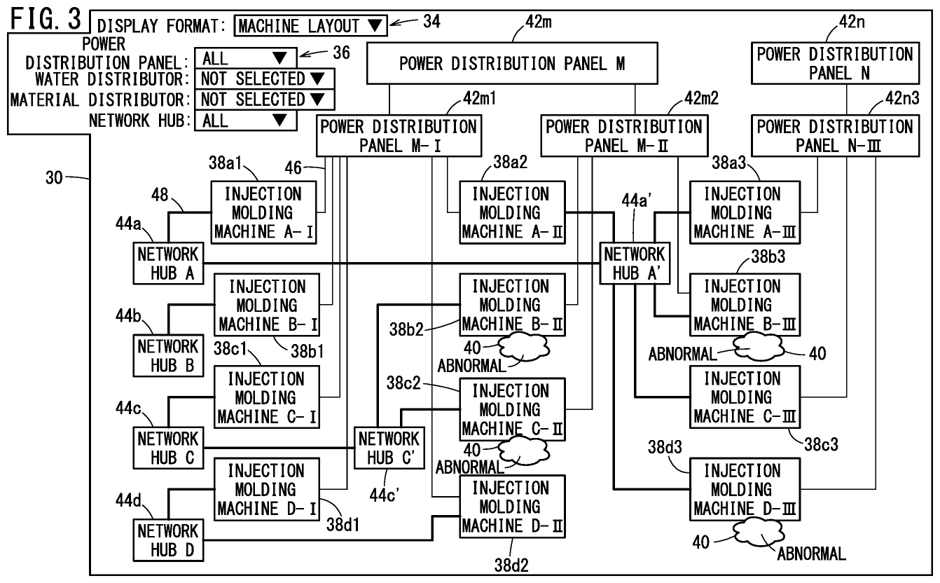

FIG. 3 is a diagram illustrating a display example of the display unit 30. The operating state of each injection molding machine 14 and the connection state between each shared device and each injection molding machine 14 are simultaneously displayed on the display unit 30.

A display format selection box 34 is displayed on the display unit 30. When the user operates the operation unit 32, the user can select a display format to be displayed on the display unit 30 from the display format selection box 34. The selected display format is acquired by the selection information acquisition unit 26 as display format selection information. In the example shown in FIG. 3, “MACHINE LAYOUT” is selected as the display format. The options in the display format selection box 34 include “TREE”, “CHART”, and “TIMELINE” in addition to “MACHINE LAYOUT”.

Shared device selection boxes 36 are displayed on the display unit 30. By operating the operation unit 32, the user can select a shared device to be displayed on the display unit 30, for each of the types of shared devices. The selected shared devices are acquired by the selection information acquisition unit 26 as shared device selection information. In the example shown in FIG. 3, “ALL” is selected for the power distribution panel and the network hub. In the example shown in FIG. 3, “NOT SELECTED” is selected for the water distributor and the material distributor. The options of each shared device selection box 36 include IDs indicating the respective shared devices, in addition to “ALL” and “NOT SELECTED”.

On the display unit 30, there are displayed injection molding machine icons 38a1, 38a2, 38a3, 38b1, 38b2, 38b3, 38c1, 38c2, 38c3, 38d1, 38d2, and 38d3, which respectively correspond to the injection molding machines 14a1, 14a2, 14a3, 14b1, 14b2, 14b3, 14c1, 14c2, 14c3, 14d1, 14d2, and 14d3. In the following description, the injection molding machine icon 38 or the injection molding machine icons 38 will be written unless referring to a specific injection molding machine icon.

When “MACHINE LAYOUT” is selected as the display format, each of the injection molding machine icons 38 is displayed at a position on the display unit 30 corresponding to the arrangement position of that injection molding machine 14 in the factory.

The operating state of each injection molding machine 14 is displayed on the display unit 30. In the example illustrated in FIG. 3, an abnormality display 40 indicating an abnormal state is displayed near each of the injection molding machine icon 38b2, the injection molding machine icon 38b3, the injection molding machine icon 38c2, and the injection molding machine icon 38d3. The injection molding machine icon 38b2, the injection molding machine icon 38b3, the injection molding machine icon 38c2, and the injection molding machine icon 38d3 correspond to the injection molding machine 14b2, the injection molding machine 14b3, the injection molding machine 14c2, and the injection molding machine 14d3, respectively. The operating states of the injection molding machine 14b2, the injection molding machine 14b3, the injection molding machine 14c2, and the injection molding machine 14d3 are abnormal states.

In the example shown in FIG. 3, “ALL” is selected for the power distribution panel and the network hub in the respective shared device selection boxes 36. When “ALL” is selected in the shared device selection box 36, it indicates that all shared devices of the corresponding type are selected. In this case, the display unit 30 displays a power distribution panel icon 42m, a power distribution panel icon 42m1, a power distribution panel icon 42m2, a power distribution panel icon 42n, and a power distribution panel icon 42n3, which correspond to the respective power distribution panels. Further, the display unit 30 displays a network hub icon 44a, a network hub icon 44a′, a network hub icon 44b, a network hub icon 44c, a network hub icon 44c′, and a network hub icon 44d corresponding to the respective network hubs. Hereinafter, the power distribution panel icon(s) 42 and the network hub icon(s) 44 will be written unless a description concerning a specific icon is given.

The display unit 30 displays a connection state between each shared device and each injection molding machine 14. In the example shown in FIG. 3, a connection display 46 indicating a connection state between each power distribution panel and each injection molding machine 14 is displayed on the display unit 30. In addition, a connection display 48 indicating a connection state between each network hub and each injection molding machine 14 is displayed on the display unit 30.

As shown in FIG. 3, “NOT SELECTED” is selected for the water distributor and the material distributor in the respective shared device selection boxes 36. In this case, no icons corresponding to the water distributors and the material distributors are displayed on the display unit 30.

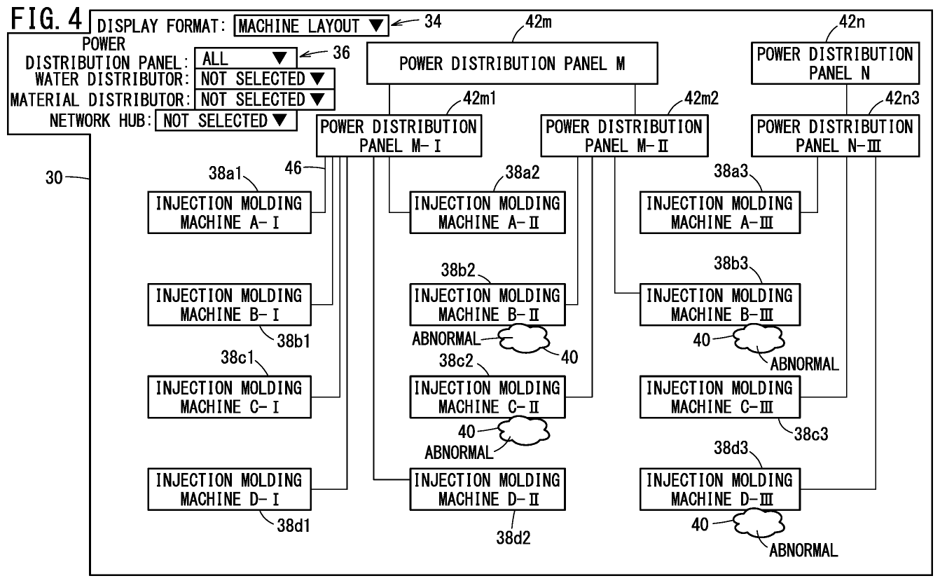

FIG. 4 is a diagram illustrating a display example of the display unit 30. In the example shown in FIG. 4, “ALL” is selected for the power distribution panel in the shared device selection box 36. In the example shown in FIG. 4, “NOT SELECTED” is selected for the water distributor, the material distributor, and the network hub. In this case, as shown in FIG. 4, the power distribution panel icons 42 are displayed on the display unit 30. Further, a connection display 46 indicating a connection state between each power distribution panel and each injection molding machine 14 is displayed on the display unit 30.

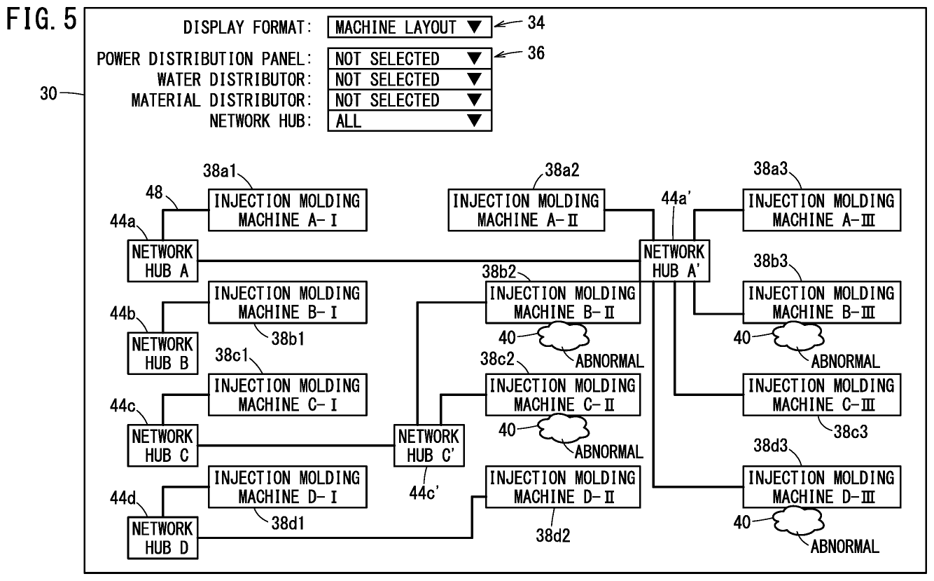

FIG. 5 is a diagram illustrating a display example of the display unit 30. In the example illustrated in FIG. 5, “ALL” is selected for the network hub in the shared device selection box 36. In the example shown in FIG. 5, “NOT SELECTED” is selected for the power distribution panel, the water distributor, and the material distributor. In this case, as shown in FIG. 5, the network hub icons 44 are displayed on the display unit 30. In addition, a connection display 48 indicating a connection state between each network hub and each injection molding machine 14 is displayed on the display unit 30.

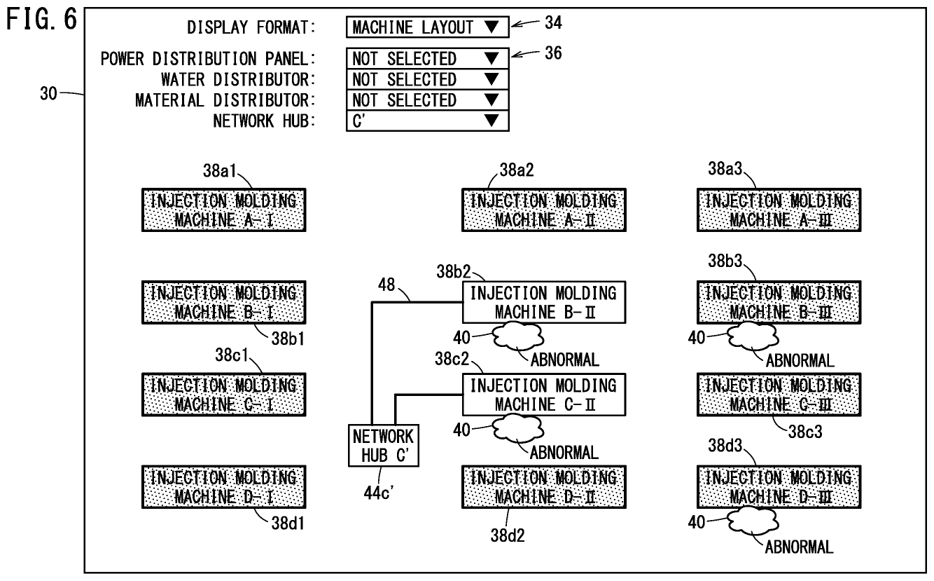

FIG. 6 is a diagram illustrating a display example of the display unit 30. In the example illustrated in FIG. 6, “C′” is selected for the network hub in the shared device selection box 36. In the example shown in FIG. 6, “NOT SELECTED” is selected for the power distribution panel, the water distributor, and the material distributor. Selection of an ID in the shared device selection box 36 indicates that an individual device has been selected for the corresponding shared device. In this case, as shown in FIG. 6, only the network hub icon 44c′ corresponding to the network hub whose ID is “C′” is displayed on the display unit 30 as the icon of the shared device. In addition, a connection display 48 indicating a connection state between the network hub whose ID is “C′” and each injection molding machine 14 is displayed on the display unit 30. The injection molding machine icon 38 corresponding to each of the injection molding machines 14 not connected to the network hub whose ID is “C′” may be displayed in a different manner from the other injection molding machine icons 38, as shown in FIG. 6. In addition, the injection molding machine icon 38 corresponding to each of the injection molding machines 14 which are not connected to the network hub whose ID is “C′” may not be displayed.

Note that the injection molding machines 14 that are not connected to the network hub whose ID is “C′” are the injection molding machine 14a1, the injection molding machine 14a2, the injection molding machine 14a3, the injection molding machine 14b1, the injection molding machine 14b3, the injection molding machine 14c1, the injection molding machine 14c3, the injection molding machine 14d1, the injection molding machine 14d2, and the injection molding machine 14d3. The injection molding machine icons 38 corresponding to the injection molding machines 14 that are not connected to the network hub whose ID is “C′” are the injection molding machine icon 38a1, the injection molding machine icon 38a2, the injection molding machine icon 38a3, the injection molding machine icon 38b1, the injection molding machine icon 38b3, the injection molding machine icon 38c1, the injection molding machine icon 38c3, the injection molding machine icon 38d1, the injection molding machine icon 38d2, and the injection molding machine icon 38d3. Display Format 2

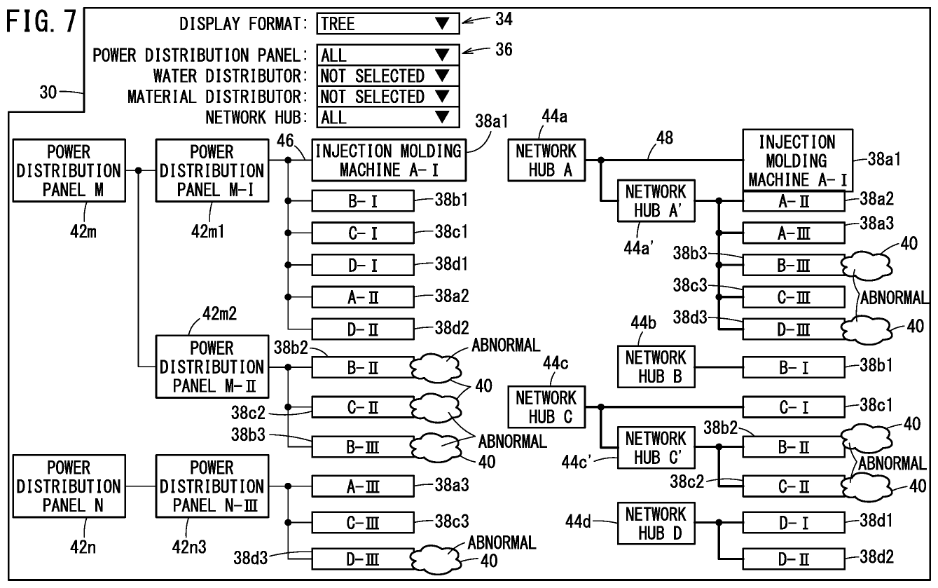

FIG. 7 is a diagram illustrating a display example of the display unit 30. In the example shown in FIG. 7, “TREE” is selected as the display format in the display format selection box 34. In the example illustrated in FIG. 7, “ALL” is selected for the power distribution panel and the network hub in the respective shared device selection boxes 36. In the example shown in FIG. 7, “NOT SELECTED” is selected for the water distributor and the material distributor.

In this case, the operating state of each injection molding machine 14 is displayed on the display unit 30. In the example illustrated in FIG. 7, the abnormality displays 40 indicating abnormal states are displayed in the vicinity of the injection molding machine icon 38b2, the injection molding machine icon 38b3, the injection molding machine icon 38c2, and the injection molding machine icon 38d3, on the display unit 30. The injection molding machine icon 38b2, the injection molding machine icon 38b3, the injection molding machine icon 38c2, and the injection molding machine icon 38d3 correspond to the injection molding machine 14b2, the injection molding machine 14b3, the injection molding machine 14c2, and the injection molding machine 14d3, respectively. The operating states of the injection molding machine 14b2, the injection molding machine 14b3, the injection molding machine 14c2, and the injection molding machine 14d3 are abnormal states.

The injection molding machine icons 38 indicating the respective injection molding machines 14, the power distribution panel icons 42 indicating the respective power distribution panels, and the network hub icons 44 indicating the respective network hubs are displayed on the display unit 30. As shown in FIG. 7, the connection state between each power distribution panel and each injection molding machine 14 is indicated by the power distribution panel icons 42, the injection molding machine icons 38, and the connection displays 46. The power distribution panel icons 42 and the injection molding machine icons 38 are arranged in a tree view. The connection display 46 indicates a connection state between the injection molding machine icon 38 and the power distribution panel icon 42.

Similarly, the connection state between each network hub and each injection molding machine 14 is indicated by the network hub icons 44, the injection molding machine icons 38, and the connection displays 48, as shown in FIG. 7. The network hub icons 44 and the injection molding machine icons 38 are arranged in a tree view. The connection display 48 indicates a connection state between the network hub icon 44 and the injection molding machine icon 38.

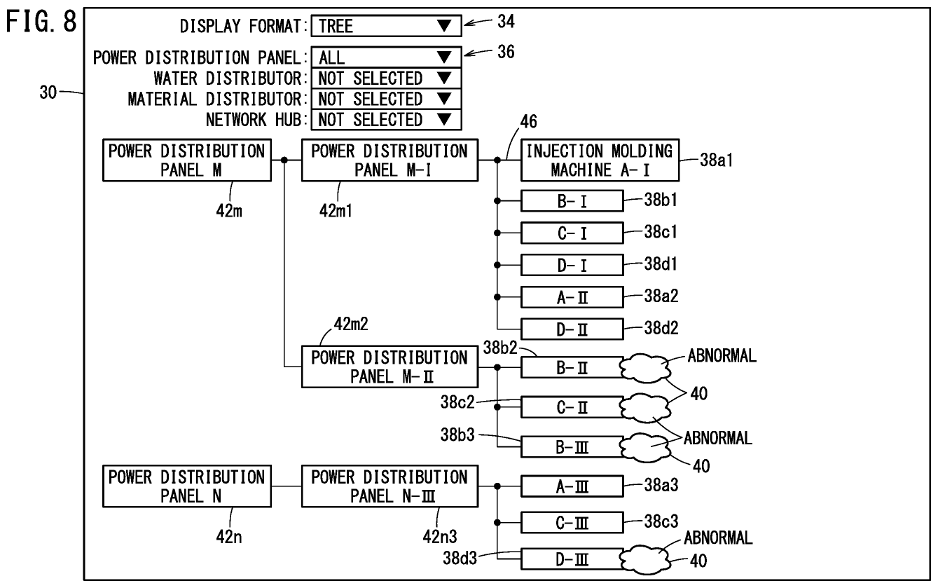

FIG. 8 is a diagram illustrating a display example of the display unit 30. In the example shown in FIG. 8, “ALL” is selected for the power distribution panel in the shared device selection box 36. In the example shown in FIG. 8, “NOT SELECTED” is selected for the water distributor, the material distributor, and the network hub.

In this case, the power distribution panel icons 42 indicating the power distribution panels are displayed on the display unit 30. As shown in FIG. 8, the connection state between each power distribution panel and each injection molding machine 14 is indicated by the injection molding machine icons 38, the power distribution panel icons 42, and the connection displays 46. The injection molding machine icons 38 and the power distribution panel icons 42 are arranged in a tree view. The connection display 46 indicates a connection state between the injection molding machine icon 38 and the power distribution panel icon 42.

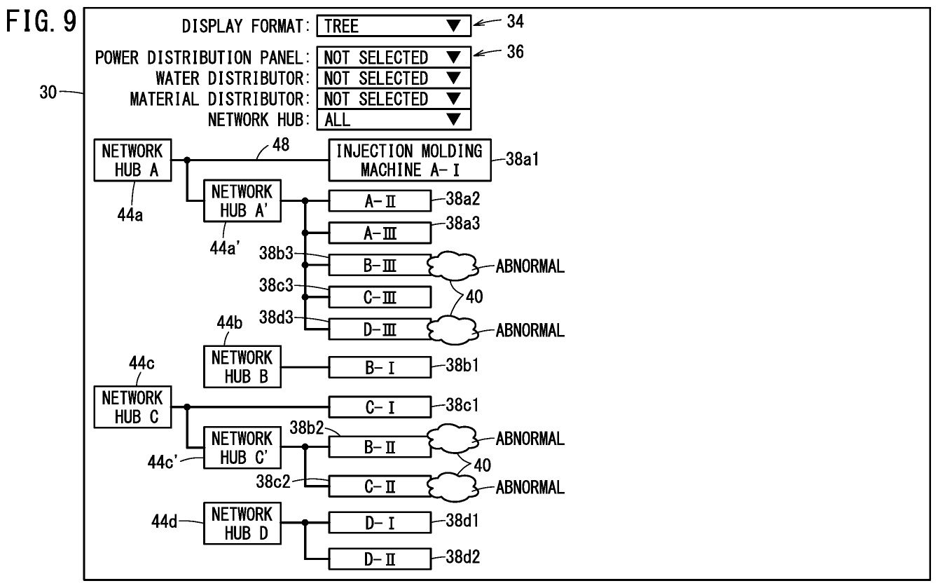

FIG. 9 is a diagram illustrating a display example of the display unit 30. In the example illustrated in FIG. 9, “ALL” is selected for the network hub in the shared device selection box 36. In the example shown in FIG. 9, “NOT SELECTED” is selected for the power distribution panel, the water distributor, and the material distributor.

In this case, the network hub icons 44 indicating the network hubs are displayed on the display unit 30. As shown in FIG. 9, the connection state between each network hub and each injection molding machine 14 is indicated by the network hub icons 44, the injection molding machine icons 38, and the connection displays 48. The network hub icons 44 and the injection molding machine icons 38 are arranged in a tree view. The connection display 48 indicates a connection state between the network hub icon 44 and the injection molding machine icon 38.

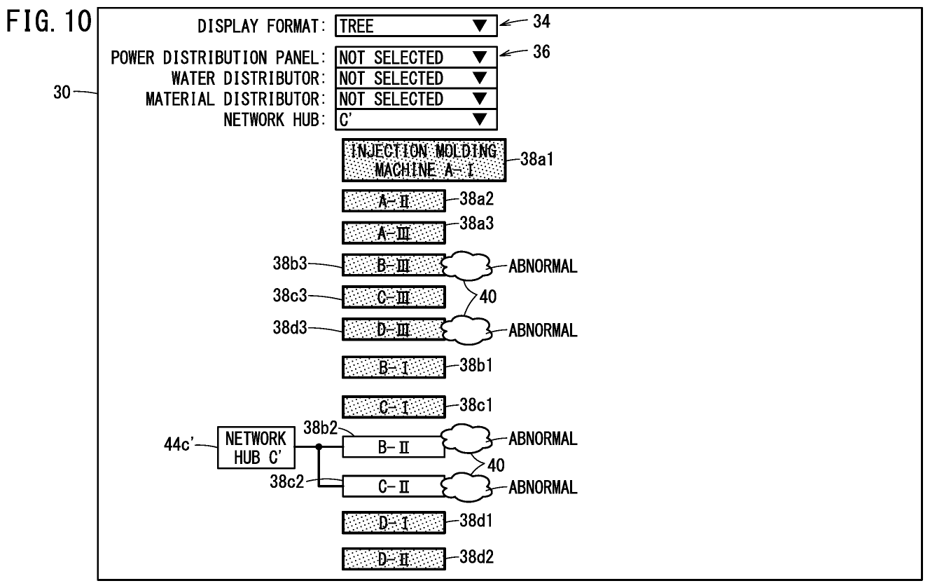

FIG. 10 is a diagram illustrating a display example of the display unit 30. In the example shown in FIG. 10, “C′” is selected only for the network hub in the shared device selection box 36. In the example shown in FIG. 10, “'NOT SELECTED” is selected for the power distribution panel, the water distributor, and the material distributor.

In this case, only the network hub icon 44c′ indicating the network hub whose ID is “C′” is displayed on the display unit 30. As shown in FIG. 10, the connection state between the network hub whose ID is “C′” and each injection molding machine 14 is indicated by the network hub icon 44c′, the injection molding machine icons 38, and the connection displays 48. The network hub icon 44c′ and the injection molding machine icons 38 are arranged in a tree view. The connection display 48 indicates a connection state between the network hub icon 44c′ and the injection molding machine icons 38.

The injection molding machine icon 38 corresponding to each of the injection molding machines 14 not connected to the network hub whose ID is “C′” may be displayed in a different manner from the other injection molding machine icons 38, as shown in FIG. 10. The injection molding machine icon 38 corresponding to each of the injection molding machines 14 which are not connected to the network hub whose ID is “C′” may not be displayed.

Note that the injection molding machines 14 that are not connected to the network hub whose ID is “C′” are the injection molding machine 14a1, the injection molding machine 14a2, the injection molding machine 14a3, the injection molding machine 14b1, the injection molding machine 14b3, the injection molding machine 14c1, the injection molding machine 14c3, the injection molding machine 14d1, the injection molding machine 14d2, and the injection molding machine 14d3. The injection molding machine icons 38 corresponding to the injection molding machines 14 that are not connected to the network hub whose ID is “C′” are the injection molding machine icon 38a1, the injection molding machine icon 38a2, the injection molding machine icon 38a3, the injection molding machine icon 38b1, the injection molding machine icon 38b3, the injection molding machine icon 38c1, the injection molding machine icon 38c3, the injection molding machine icon 38d1, the injection molding machine icon 38d2, and the injection molding machine icon 38d3. Display Format 3

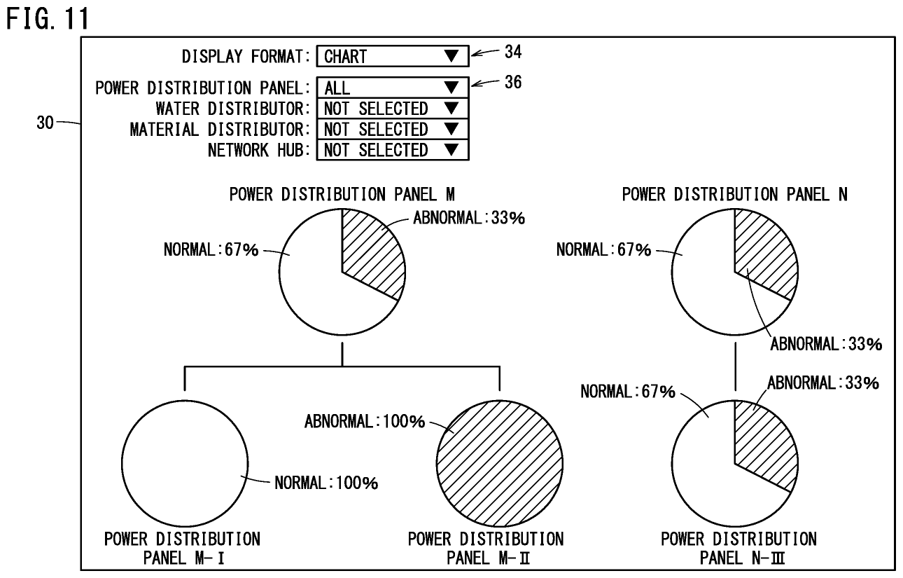

FIG. 11 is a diagram illustrating a display example of the display unit 30. In the example shown in FIG. 11, “CHART” is selected as the display format in the display format selection box 34. In the example shown in FIG. 11, “ALL” is selected for the power distribution panel in the shared device selection box 36. In the example shown in FIG. 11, “NOT SELECTED” is selected for the water distributor, the material distributor, and the network hub.

In this case, the display unit 30 displays, for each power distribution panel, a pie chart indicating the proportion of the injection molding machines 14 that are in a normal state and the proportion of the injection molding machines 14 that are in an abnormal state, among the injection molding machines 14 connected to the power distribution panel. Display Format 4

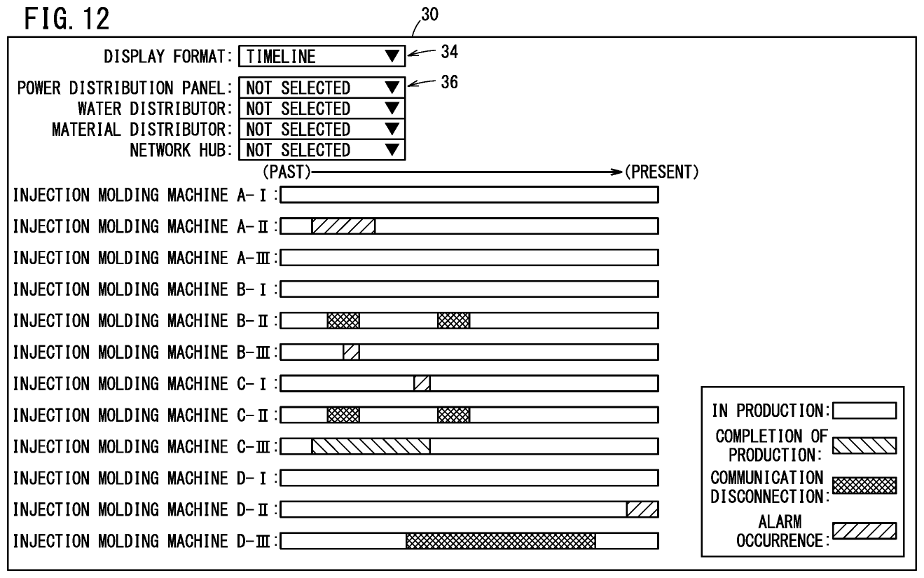

FIG. 12 is a diagram illustrating a display example of the display unit 30. In the example shown in FIG. 12, “TIMELINE” is selected as the display format in the display format selection box 34. In the example shown in FIG. 12, in the shared device selection box 36, “NOT SELECTED” is selected for the power distribution panel, the water distributor, the material distributor, and the network hub.

In this case, for each injection molding machine 14, the timeline diagram of the operating state from the past to the present is displayed on the display unit 30. Since “NOT SELECTED” is selected for all of the power distribution panel, the water distributor, the material distributor, and the network hub in the respective shared device selection boxes 36, as shown in FIG. 12, the display indicating the timeline of the operating state from the past to the present is displayed in the order of the IDs of the injection molding machines 14.

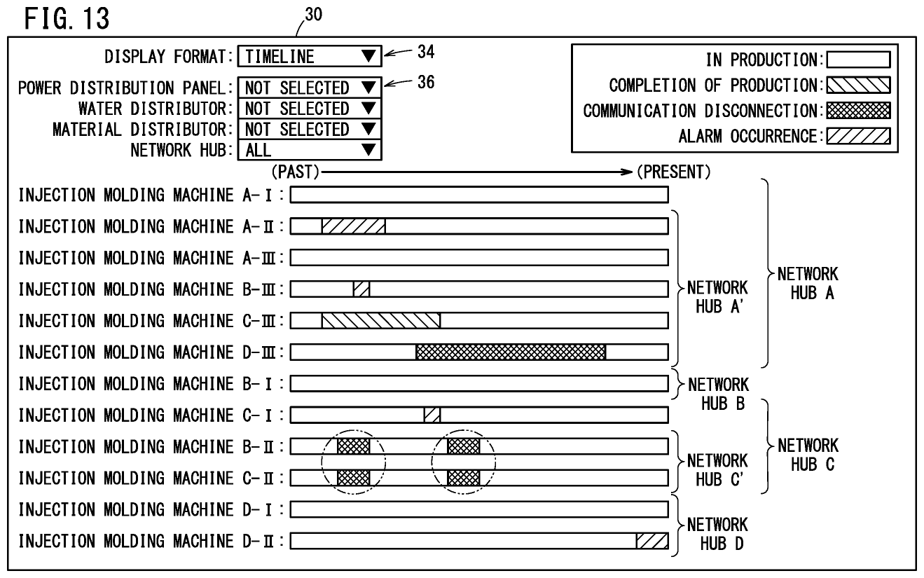

FIG. 13 is a diagram illustrating a display example of the display unit 30. In the example illustrated in FIG. 13, “ALL” is selected for the network hub in the shared device selection box 36. In the example shown in FIG. 13, “NOT SELECTED” is selected for the power distribution panel, the water distributor, and the material distributor. In this case, as shown in FIG. 13, the displays indicating the time changes of the operating states of the injection molding machines 14 that are connected to the same network hub are displayed so as to be vertically adjacent to each other. Display Control Process

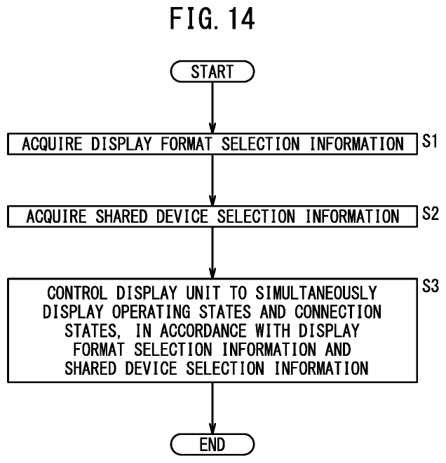

FIG. 14 is a flowchart showing a flow of display control process performed in the centralized management apparatus 10. The display control process is repeatedly executed at regular time intervals.

In step S1, the selection information acquisition unit 26 acquires the display format selection information. Thereafter, the process transitions to step S2.

In step S2, the selection information acquisition unit 26 acquires the shared device selection information. Thereafter, the process transitions to step S3.

In step S3, the display control unit 28 controls the display unit 30 to simultaneously display the operating states of the respective injection molding machines 14 and the connection states between each of the shared devices and each of the injection molding machines 14, on the display unit 30. A display corresponding to the acquired display format selection information and shared device selection information is displayed on the display unit 30. Thereafter, the display control process is ended. Operations and Effects

In the present embodiment, the display control unit 28 controls the display unit 30 to simultaneously display the operating state of each injection molding machine 14 and the connection state between each shared device and each injection molding machine 14, on the display unit 30. For example, when the displays shown in FIGS. 3 and 7 are displayed on the display unit 30, the user can easily recognize that an abnormality has occurred in all the injection molding machines 14 (the injection molding machine 14b2, the injection molding machine 14b3, and the injection molding machine 14c2) that are connected to the power distribution panel whose ID is “M-II”. Alternatively, the user can easily recognize that an abnormality has occurred in all the injection molding machines 14 (the injection molding machine 14b2 and the injection molding machine 14c2) that are connected to the network hub whose ID is “C′”. Accordingly, the user can easily predict that there is a high possibility that the cause of the occurrence of the abnormality is not derived from the individual injection molding machines 14 but derived from the power distribution panel whose ID is “M-II” or the network hub whose ID is “C′”.

Further, in the present embodiment, the display control unit 28 controls the display unit 30 to simultaneously display the operating state of each injection molding machine 14 and the connection state between each shared device of the type selected by the user and each injection molding machine 14, on the display unit 30. For example, when the displays shown in FIGS. 4, 5, 8, and 9 are displayed on the display unit 30, the user can confirm the connection state between each shared device and each injection molding machine 14 for each of the types of shared devices.

Further, in the present embodiment, the display control unit 28 controls the display unit 30 to simultaneously display the operating state of each injection molding machine 14 and the connection state between an individual shared device selected by the user and each injection molding machine 14, on the display unit 30. For example, when the displays shown in FIGS. 6 and 10 are displayed on the display unit 30, the user can confirm the connection state between the shared device and each injection molding machine 14, for each of the individual shared devices.

In the present embodiment, the display control unit 28 controls the display unit 30 to display the connection state between the shared devices and the injection molding machines 14, in a tree view, on the display unit 30. For example, when the displays shown in FIGS. 7, 8, 9, and 10 are displayed on the display unit 30, the user can easily recognize the injection molding machines 14 connected to the same shared device.

In addition, in the present embodiment, the display control unit 28 controls the display unit 30 and causes the display unit 30 to display, as a chart, the proportion of the injection molding machines that are in the normal operating state and the proportion of the injection molding machines that are in the abnormal operating state, among the injection molding machines 14 connected to each of the shared devices. For example, when the display illustrated in FIG. 11 is displayed on the display unit 30, the user can easily recognize, for each shared device, the proportion of the injection molding machines 14 in which an abnormality has occurred, among the injection molding machines 14 connected to the shared device.

In the present embodiment, the display control unit 28 controls the display unit 30 to display a timeline diagram of the operating state of each injection molding machine 14, on the display unit 30. For example, when the displays shown in FIGS. 12 and 13 are displayed on the display unit 30, the user can check occurrence of an abnormality in each injection molding machine 14 retrospectively. In particular, as shown in FIG. 13, when the displays indicating the operating states of the injection molding machines 14 connected to the same shared device are displayed on the display unit 30 so as to be vertically adjacent to each other, the user can recognize that communication disconnection occurs simultaneously in the injection molding machine 14 having the ID “B-II” and the injection molding machine 14 having the ID “C-II” in the time zone indicated by the circle in FIG. 13. The user can easily predict that an abnormality has occurred in the network hub with the ID “C′” to which both the injection molding machine 14 with the ID “B-II” and the injection molding machine 14 with the ID “C-II” are connected. Invention Obtained from the Embodiments

The invention graspable from the embodiments described above will be described below.

The centralized management apparatus (10) is communicably connected to the plurality of production machines (14) and configured to manage the operating state including the abnormal state of each of the production machines. The plurality of the production machines are connected to each of the shared devices of the same type. The centralized management apparatus includes: the operating state acquisition unit (18) configured to acquire data of the operating state of each of the production machines; the connection state acquisition unit (22) configured to acquire data of a connection state between each of the shared devices and each of the production machines; and the display control unit (28) configured to control the display unit (30) to simultaneously display the operating state of each of the production machines and the connection state between each of the shared devices and each of the production machines, on the display unit.

In the centralized management apparatus, the type of the shared devices may include at least one of five types including: the power distribution panel that distributes electric power to the production machines; the water distributor that distributes water to the production machines; the water discharger that discharges water used in the production machines; the material distributor that distributes material to the production machines; and the network hub that connects the production machines to the communication network.

In the centralized management apparatus, each of the production machines may be connected to the shared devices of the plurality of types, the centralized management apparatus may further include the selection information acquisition unit (26) configured to acquire information on the type of the shared devices that has been selected by the user from among the plurality of types, and the display control unit may control the display unit to simultaneously display the operating state of each of the production machines and the connection state between each of the shared devices of the type that has been selected and each of the production machines, on the display unit.

The centralized management apparatus may further include the selection information acquisition unit configured to acquire information on an individual shared device that has been selected by the user from among the shared devices. The display control unit may control the display unit to simultaneously display the operating state of each of the production machines and the connection state between the individual shared device that has been selected and each of the production machines, on the display unit.

In the centralized management apparatus, the display control unit may control the display unit to display the connection state between each of the shared devices and each of the production machines in a tree view, on the display unit.

In the centralized management apparatus, the display control unit may control the display unit to display, as a chart, the proportion of production machines the operating state of which are the normal state and the proportion of production machines the operating state of which are the abnormal state, among the production machines connected to each of the shared devices, on the display unit.

In the centralized management apparatus, the display control unit may control the display unit to display the timeline of the operating state of each of the production machines, on the display unit.

The control method is for controlling the centralized management apparatus that is communicably connected to the plurality of production machines and that manages the operating state including the abnormal state of each of the production machines. The plurality of the production machines are connected to each of the shared devices of the same type. The control method includes: the operating state acquisition step of acquiring data of the operating state of each of the production machines; the connection state acquisition step of acquiring data of the connection state between each of the shared devices and each of the production machines; and the display control step of controlling the display unit to simultaneously display the operating state of each of the production machines and the connection state between each of the shared devices and each of the production machines, on the display unit.

In the method for the centralized management apparatus, the type of the shared devices may include at least one of five types including: the power distribution panel that distributes electric power to the production machines; the water distributor that distributes water to the production machines; the water discharger that discharges water used in the production machines; the material distributor that distributes material to the production machines; and the network hub that connects the production machines to the communication network.

In the control method of the centralized management apparatus, each of the production machines may be connected to the shared devices of the plurality of types. The control method may further include the selection information acquisition step of acquiring information on the type of the shared devices that has been selected by the user from among the plurality of types, and the display control step may include controlling the display unit to simultaneously display the operating state of each of the production machines and the connection state between each of the shared devices of the selected type and each of the production machines, on the display unit.

The control method of the centralized management apparatus may further include: the selection information acquisition step of acquiring information on the individual shared device that has been selected by the user from among the shared devices. The display control step may include controlling the display unit to simultaneously display the operating state of each of the production machines and the connection state between the selected individual shared device and each of the production machines, on the display unit.

In the control method of the centralized management apparatus, the display control step may include controlling the display unit to display the connection state between each of the shared devices and each of the production machines in a tree view, on the display unit.

In the control method of the centralized management apparatus, the display control step may include controlling the display unit to display, as a chart, the proportion of production machines the operating state of which are the normal state and the proportion of production machines the operating state of which are the abnormal state, among the production machines connected to each of the shared devices, on the display unit.

In the control method of the centralized management apparatus, the display control step may include controlling the display unit to display the timeline diagram of the operating state of each of the production machines, on the display unit.

1. A centralized management apparatus communicably connected to a plurality of production machines and configured to manage an operating state including an abnormal state of each of the production machines,
wherein a plurality of the production machines are connected to each of shared devices of a same type, the centralized management apparatus comprising:
an operating state acquisition unit configured to acquire data of the operating state of each of the production machines;
a connection state acquisition unit configured to acquire data of a connection state between each of the shared devices and each of the production machines; and
a display control unit configured to control a display unit to simultaneously display the operating state of each of the production machines and the connection state between each of the shared devices and each of the production machines, on the display unit.

2. The centralized management apparatus according to claim 1, wherein
the type of the shared devices includes at least one of five types including: a power distribution panel that distributes electric power to the production machines; a water distributor that distributes water to the production machines; a water discharger that discharges water used in the production machines; a material distributor that distributes material to the production machines; and a network hub that connects the production machines to a communication network.

3. The centralized management apparatus according to claim 1, wherein
the type comprises a plurality of types, and each of the production machines is connected to the shared devices of the plurality of types,
the centralized management apparatus further comprises a selection information acquisition unit configured to acquire information on a type of the shared devices that has been selected by a user from among the plurality of types, and
the display control unit controls the display unit to simultaneously display the operating state of each of the production machines and the connection state between each of the shared devices of the type that has been selected and each of the production machines, on the display unit.

4. The centralized management apparatus according to claim 1, further comprising:
a selection information acquisition unit configured to acquire information on an individual shared device that has been selected by a user from among the shared devices,
wherein the display control unit controls the display unit to simultaneously display the operating state of each of the production machines and the connection state between the individual shared device that has been selected and each of the production machines, on the display unit.

5. The centralized management apparatus according to claim 1, wherein
the display control unit controls the display unit to display the connection state between each of the shared devices and each of the production machines in a tree view, on the display unit.

6. The centralized management apparatus according to claim 1, wherein
the display control unit controls the display unit to display, as a chart, a proportion of production machines the operating state of which are a normal state and a proportion of production machines the operating state of which are an abnormal state, among the production machines connected to each of the shared devices, on the display unit.

7. The centralized management apparatus according to claim 1, wherein
the display control unit controls the display unit to display a timeline diagram of the operating state of each of the production machines, on the display unit.

8. A control method of a centralized management apparatus that is communicably connected to a plurality of production machines and manages an operating state including an abnormal state of each of the production machines,
wherein a plurality of the production machines are connected to each of shared devices of a same type, the control method comprising:
an operating state acquisition step of acquiring data of the operating state of each of the production machines;
a connection state acquisition step of acquiring data of a connection state between each of the shared devices and each of the production machines; and
a display control step of causing a display unit to simultaneously display the operating state of each of the production machines and the connection state between each of the shared devices and each of the production machines.

9. The control method of the centralized management apparatus according to claim 8, wherein
the type of the shared devices includes at least one of five types including: a power distribution panel that distributes electric power to the production machines; a water distributor that distributes water to the production machines; a water discharger that discharges water used in the production machines; a material distributor that distributes material to the production machines; and a network hub that connects the production machines to a communication network.

10. The control method of the centralized management apparatus according to claim 9, wherein
the type comprises a plurality of types, and each of the production machines is connected to the shared devices of the plurality of types,
the control method further comprises a selection information acquisition step of acquiring information on a type of the shared devices that has been selected by a user from among the plurality of types, and
the display control step includes controlling the display unit to simultaneously display the operating state of each of the production machines and the connection state between each of the shared devices of the type that has been selected and each of the production machines, on the display unit.

11. The control method of the centralized management apparatus according to claim 8, further comprising:
a selection information acquisition step of acquiring information on an individual shared device that has been selected by a user from among the shared devices,
wherein the display control step includes controlling the display unit to simultaneously display the operating state of each of the production machines and the connection state between the individual shared device that has been selected and each of the production machines, on the display unit.

12. The control method of the centralized management apparatus according to claim 8, wherein
the display control step includes controlling the display unit to display the connection state between each of the shared devices and each of the production machines in a tree view, on the display unit.

13. The control method of the centralized management apparatus according to claim 8, wherein
the display control step includes controlling the display unit to display, as a chart, a proportion of production machines the operating state of which are a normal state and a proportion of production machines the operating state of which are an abnormal state, among the production machines connected to each of the shared devices, on the display unit.

14. The control method of the centralized management apparatus according to claim 8, wherein
the display control step includes controlling the display unit to display a timeline diagram of the operating state of each of the production machines, on the display unit.
